(19) United States
(12) Patent Application Publication
(10) Pub. No.: US 2008/0077540 A1
(43) Pub. Date: Mar. 27, 2008

(54) Derivatives for copyrights

(76) Inventor: Bidyut Niyogi, Millburn, NJ (US)

Correspondence Address: Bidyut K. Niyogi, 78 Cypress Street, Millburn, NJ, 07041, US

(21) Appl. No.: 11/899,178

(22) Filed: Sep. 6, 2007

Related U.S. Application Data
(60) Provisional application No. 60/846,880, filed on Sep. 25, 2006.

(51) Int. Cl. G06Q 40/00

(52) U.S. Cl. 705/36 R

(57) ABSTRACT

The present invention relates to a coordinated multiple step process for risk management of credit derivatives, coordinated by a computer and or mathematical models, for a copyright product valued for a specific period of time as defined by copyright laws depending on the life span of a product derived from the specific copyright, the improvement of the copyright product related directly to the risk value credit derivative provided by at least a financial institution for a predetermined region or country with different financial platforms and different hybrid financial instruments of different currencies for capital investment, and the expected return in investment on the basis of the credit and risk evaluated for at least each copyright article, and each specific region or country, and the predetermined time of utilization of the innovation.

This patent application follows from Provisional Patent Application No. 60/846,880 with filing date Sep. 25, 2006.

### DERIVATIVES FOR COPYRIGHTS

The present invention relates to an innovative process that is coordinated with a computer and mathematical models and uses steps, for a quantitative credit risk derivative, and value risk assessment, specifically as applicable to the areas of investment banking and original works applicable to copyright protection laws, of the USA and other capital market countries.

The coordinated process steps uses an industrial property including at least an article, or work of art, a literary or musical production, utilizing for this innovation such as a book or piece of music, or such original work that is within the domain of copyright protective laws. Any improvement resulting from such a combination of such innovations that result in an improvement of the copyright property, for a specified financial consideration depending on the copyright value risk, over a predetermined length of time as determined by the life of the copyright.

Suitably, this form of innovation is considered as eligible for protection as a patent and as granted in U.S. Pat. No. 5,193,056 to Signature Financial Group, Mar. 9, 1995, since it involves considerable practical appreciation and provides a useful, concrete and tangible result.

To evaluate a quantitative analysis by a financial institution for the establishment of a financial contract for the specified property whose value is established from the improvement of the copyright probability steps of the process, between an owner of the copyright, the copyright product and the life of the author of the copyright, or such a person or persons whose work is applicable to the copyright, and the financial institution.

It should be appreciated that the creator or innovator of the copyrights may only have a book or piece of novel music, and may wish to expand its growth into other areas.

It should be appreciated that all improvement probability processes have a risk valuation derived from their future financial performance, with agreements and contracts that result form it.

It will be noted that copyright is defined as an original work of art, applicable to copyright in general created after Jan. 1, 1978 endures for a term consisting of the life of the author and 70 years after the author's death, or a composer of music.

It should be conclusive that the copyright can be protected in various subjects and in general as the following:

a) Literary work.

b) Musical works, including words.

c) Dramatic plays and work, including music.

d) Pantomimes and choreographic works.

e) Pictorial, graphic and sculptural works.

f) Motion pictures and other audiovisual works.

g) Sound recording.

h) Architectural works.

According to the present invention a coordinated process for risk management of credit derivatives, coordinated by a computer, and mathematical models for a copyright protected product valued for a specific period of time as defined by copyright laws depending on the life span of a product derived from the copyright, the improvement of the copyright product related directly to the risk value credit derivative provided by at least a financial institution for a specific region or country with different financial platforms and different hybrid financial instruments of different currencies for capital investment, and the expected return in investment on the basis of the credit and risk evaluated for each specific region, and predetermined time of utilization of the invention in the market place.

Conveniently, the credit risk to be managed by the financial institution provided for may be for a specified copyright product or a group of products, for a predetermined time, for a specified country assigned to a copyright product or a group of products. For example, a book with stage and movie production rights, and the music that follows with its use, or the television and other media use in serial form for broadcast use.

Advantageously, the credit risk derivative to be managed and its risk value evaluated with a corresponding risk protection for a specific country or region for a predetermined time, or the life of each copyrighted products, and formulated as a collective work, in which the different rights may be assembled collectively and or separated as necessary.

Suitably, the inventive value and the credit risk management in association with the corresponding risk protection for a bundle of such copyright products resulting from at least one or more copyright product for predetermined length of time and at least for one or more defined geographical regions of the world. The risk being managed by structured investment values.

It will be appreciated that the credit risk derivative management provides for the corresponding adjustment for the life of each copyright product with the predetermined credit risk protection, and value adjusted risk for each such copyright protected product or article, in a predetermined country or region.

As a matter of common general knowledge a copyright region is defined to limit itself to one geographical country or a collection of geographical countries, using a common language, or different languages, utilizing one or different currencies for each transaction.

On the question of a life of a copyright it is in the USA limited to seventy years from the time of death of the author, composer, or creator of the copyright.

A copyright is feasible for registration at any time by delivery to the Copyright Office together with the requisite application and fee, with the form provided by the Registrar of Copyright, at the office located at 101 Independence Ave. SE, Washington D.C. 20559-6000. USA. Most major industrial countries have their respective offices located in their capitals.

What I claim is:

1. A coordinated multiple step process for risk management of credit derivatives, coordinated by a computer and or mathematical models, for a copyright product valued for a specific period of time as defined by copyright laws depending on the life span of a product derived from the specific copyright, the improvement of the copyright product related directly to the risk value credit derivative provided by at least a financial institution for a predetermined region or country with different financial platforms and different hybrid financial instruments of different currencies for capital investment, and the expected return in investment on the basis of the credit and risk evaluated for at least each copyright article, and each specific region or country, and the predetermined time of utilization of the innovation.

2. A multiple step process as claimed in claim 1, in which the credit risk to be managed by at least a financial institution provided for a predetermined copyrights article, or a group of products, for a predetermined time, for at least a specific country assigned to a copyright article, or product or a group of products.

3. A multiple step process as claimed in claim 1, characterized by the credit risk derivative to be managed and its risk value evaluated with a corresponding risk protection through structured investment values for at least a specific country or region for a predetermined time or the life of each copyright article and formulated as a collective work, in which the different rights may be assembled collectively and or separately.

4. A multiple step process as claimed in claim 1, in which the inventive value and the credit risk management in association with the corresponding risk protection for a bundle of such copyright products resulting from at least one or more copyright product for a predetermined length of time and at least for one or more defined geographical region of the world.

5. A multiple step process as claimed in claim 1, in which a copyright region is defined to limit itself at least one geographical country or a collection of geographical countries, using a common language or different languages, utilizing at least one or multiple currencies.

6. A multiple step process as claimed in claim 1, characterized by the copyright article being movable and made available to any geographical location.
